(19) United States
(12) Patent Application Publication
(10) Pub. No.: US 2022/0235172 A1
(43) Pub. Date: Jul. 28, 2022

(54) SILYLATED ADDUCTS, SILYLATED POLYMERS AND COMPOSITIONS COMPRISING SAME

(71) Applicant: BOSTIK SA, Colombes (FR)

(72) Inventor: Boris COLIN, VENETTE (FR)

(21) Appl. No.: 17/617,329

(22) PCT Filed: Jun. 11, 2020
(86) PCT No.: PCT/FR2020/050990

§ 371 Date: Dec. 8, 2021

(30) Foreign Application Priority Data
Jun. 13, 2019 (FR) FR1906297

(51) Int. Cl. C08G 18/83; C08G 18/48; C08G 18/75; C08G 18/22; C09K 3/10; C07F 7/18

(52) U.S. Cl. CPC C08G 18/837; C08G 18/4825; C08G 18/755; C09K 2200/065; C09K 3/1021; C07F 7/1804; C07F 7/1892; C08G 18/227

(57) ABSTRACT

The present invention relates to a compound of the following formula (I):
Formula (I),

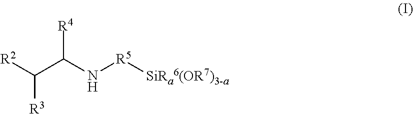

as well as the polyurethanes obtained from these compounds, and their uses in sealant formulations.

### FIELD OF THE INVENTION

The present invention relates to a silylated adduct, and also to the process for preparing same.

The present invention also relates to the silylated polymers obtained from said silylated adducts, and also to compositions comprising same.

### TECHNOLOGICAL BACKGROUND

Silylated polymers are typically used as adhesives, sealants and coatings, for example in the aeronautical, motor vehicle or construction industry. Such polymers generally comprise end groups of alkoxysilane type connected, directly or indirectly, to a main chain of polyether or polyurethane type. Among industrially available silylated polymers, mention may be made of silylated polyethers obtained by hydrosilylation of the corresponding diallyl ethers, silylated polyethers obtained by reaction of a polyether polyol or of a hydroxyl-terminated polyurethane with an isocyanatosilane (STPE/STPU), and silylated polyurethanes obtained by reaction of an isocyanate-terminated prepolymer and an aminosilane comprising alkoxysilane functions (SPUR).

The abovementioned silylated polyurethanes typically have a high viscosity, which makes the handling thereof and the uses thereof more complex. Moreover, in certain cases, these silylated polyurethanes also exhibit stability problems regarding the change in viscosity over time, in particular when they are synthesized using aminosilane comprising a primary amine.

Moreover, the most common silylated polyurethanes lead to the emission and the presence of residual methanol resulting from the crosslinking reaction. In view of the constant development of European regulations, it is now necessary to find alternatives to limit or avoid the generation of methanol in products.

There is therefore a need for new silylated polymers that make it possible to at least partially overcome at least one of the abovementioned drawbacks.

### DESCRIPTION OF THE INVENTION

In the present application, unless otherwise indicated:

the amounts expressed in the percentage form correspond to weight/weight percentages;

the hydroxyl number of an alcoholic compound represents the amount of hydroxyl functions per gram of product, and is expressed in the form of the equivalent number of milligrams of potassium hydroxide (KOH) used in the assay of the hydroxyl functions, per gram of product;

the viscosity measurement at 23° C. (or at 100° C.) may be performed using a Brookfield viscometer according to the standard ISO 2555. Typically, the measurement taken at 23° C. (or at 100° C.) may be performed using a Brookfield RVT viscometer with a spindle suitable for the viscosity range and at a rotational speed of 20 revolutions per minute (rpm);

the number-average molecular weights (Mn) of the polyols, expressed in g/mol, are calculated from their hydroxyl numbers and from their functionalities.

### A. Compounds of Formula (I)

The present invention relates to a compound of formula (I) below:

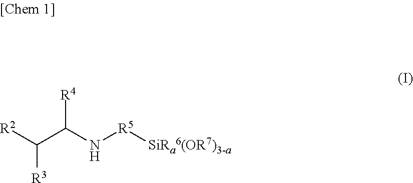

wherein:
R² is a radical selected from the group consisting of —C(O)OR¹, —C(O)NH₂, —CONHR¹, —C(O)N(R¹)₂, —CN, —NO₂, —PO(OR¹)₂, —SO₂R¹ and —SO₂OR¹;
R³ is a radical selected from the group consisting of a hydrogen atom, —CH₃, —R¹, —C(O)OR¹ and —CH₂C(O)OR¹;
R⁴ is a radical selected from the group consisting of a hydrogen atom, —R¹, —C(O)OR¹ and —CN;
R¹ represents an organic radical comprising from 1 to 20 carbon atoms, optionally comprising at least one heteroatom such as for example O;
R⁵ is a linear or branched divalent alkylene radical comprising from 1 to 12 carbon atoms;
R⁶ is a linear or branched alkyl group comprising from 1 to 8 carbon atoms, or an alkoxy group comprising from 1 to 8 carbon atoms;
R⁷ is a group —N═C(Rⁱ)Rⁱ wherein:
   Rⁱ is a radical selected from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   Rⁱ is a radical selected from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   or Rⁱ and R^{j} together form an aliphatic ring comprising from 3 to 14 carbon atoms, preferably from 4 to 8 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom;
a is an integer equal to 0, 1 or 2, preferably equal to 0 or 1.

The compounds of formula (I) are preferably those for which R¹ represents a linear or branched alkyl group comprising from 1 to 20 carbon atoms, preferably from 1 to 10 carbon atoms, and even more preferentially from 1 to 5 carbon atoms.

Preferably, in the compounds of abovementioned formula (I):
R² is a radical —C(O)OR¹; and/or
R³ is a radical selected from the group consisting of a hydrogen atom, —C(O)OR¹ and —CH₂C(O)OR¹; and/or
R⁴ is a hydrogen atom or —C(O)OR¹;
R¹ preferably representing a linear or branched alkyl group comprising from 1 to 20 carbon atoms, preferably from 1 to 10 carbon atoms, and even more preferentially from 1 to 5 carbon atoms.

More preferably, in the compounds of abovementioned formula (I):
R² is a radical —C(O)OR¹; and
R³ is a radical selected from the group consisting of a hydrogen atom, —C(O)OR¹ and —CH₂C(O)OR¹; and
R⁴ is a hydrogen atom or —C(O)OR¹;
R¹ representing a linear or branched alkyl group comprising from 1 to 20 carbon atoms, preferably from 1 to 10 carbon atoms, and even more preferentially from 1 to 5 carbon atoms.

In the context of the invention, the “alkyl”, “aryalkyl” and “aryl” groups may be substituted or unsubstituted.

The compounds of abovementioned formula (I) preferably have one of the following formulae (I-1), (I-2) or (I-3):

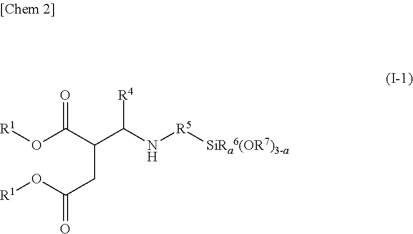

wherein a, R¹, R⁵, R⁶ and R⁷ are as defined above, and R⁴ represents H;

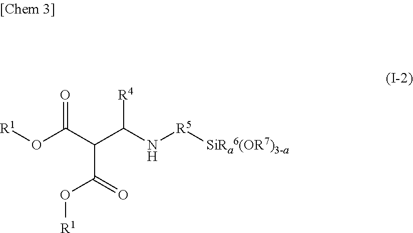

wherein a, R¹, R⁵, R⁶, R⁷ are as defined above, and R⁴ represents H;

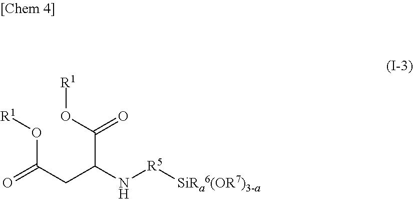

wherein a, R¹, R⁵, R⁶ and R⁷ are as defined above.

Preferably, in the abovementioned formulae (I), (I-1), (I-2) and (I-3):
each R¹, which may be identical or different, represents, independently of one another, a linear or branched alkyl group comprising from 1 to 12 carbon atoms, preferentially from 1 to 8 carbon atoms, and even more preferentially from 1 to 5 carbon atoms; and
R⁴ represents a hydrogen atom; and
R⁵ represents a linear or branched divalent alkylene radical comprising from 1 to 6 carbon atoms, preferentially 3 carbon atoms.

According to one embodiment, in the formulae (I), (I-1), (I-2) and (I-3):
Rⁱ represents a hydrogen atom, or a linear or branched alkyl radical comprising from 1 to 10 carbon atoms such as, for example, a methyl; and/or
Rⁱ represents a linear or branched alkyl radical comprising from 1 to 8 carbon atoms, preferably from 1 to 6 carbon atoms, more preferably from 1 to 5 carbon atoms, or a phenyl radical, or a radical —CH₂—N(G¹G²) where G¹ and G² represent, independently of one another, preferably a methyl, ethyl, propyl, butyl, pentyl or benzyl (—CH₂—C₆H₅) radical, more preferably a methyl, ethyl, propyl or benzyl radical.

According to one embodiment, in formulae (I), (I-1), (I-2) and (I-3), Rⁱ and R^{j} together form an aliphatic ring comprising from 5 to 12 carbon atoms, preferably 6 carbon atoms, said aliphatic ring being optionally substituted with at least one alkyl radical comprising from 1 to 4 carbon atoms, and said ring optionally comprising one or more heteroatoms selected from an oxygen atom, a sulfur atom or a nitrogen atom, said nitrogen atom then not being bonded to a hydrogen atom. Preferably, the ring is neither substituted nor comprises a heteroatom.

The compounds of the abovementioned formulae (I), (I-1), (I-2) and (I-3) are preferably those for which R⁷ is a group —N═C(Rⁱ)Rⁱ wherein:
Rⁱ is a linear or branched alkyl radical comprising from 1 to 4 carbon atoms;
Rⁱ represents a linear or branched alkyl radical comprising from 1 to 8 carbon atoms, preferably from 1 to 6 carbon atoms, more preferably from 1 to 5 carbon atoms, or a phenyl radical.

The compounds of formula (I) are preferably compounds of formula (I-1) as defined above.

According to a preferred embodiment, the compounds of formula (I) are chosen from the following compounds:

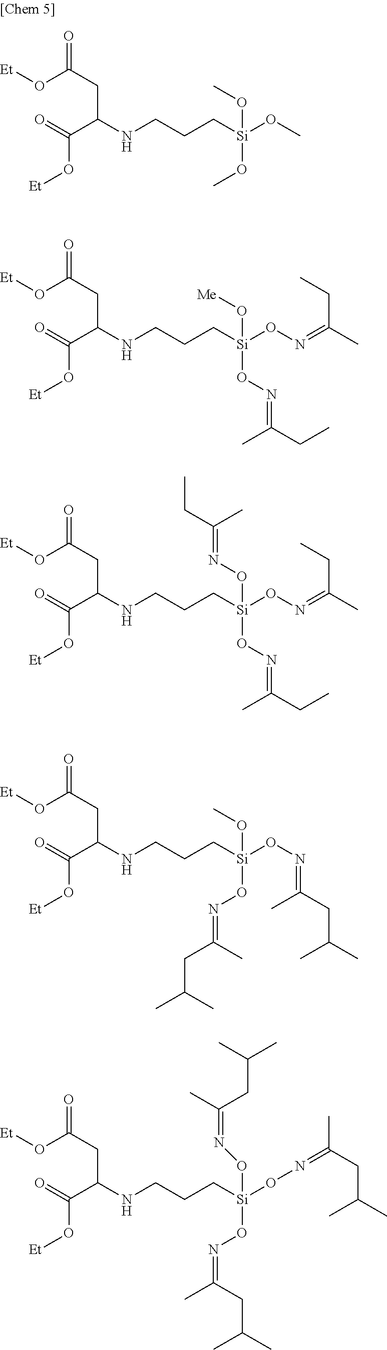

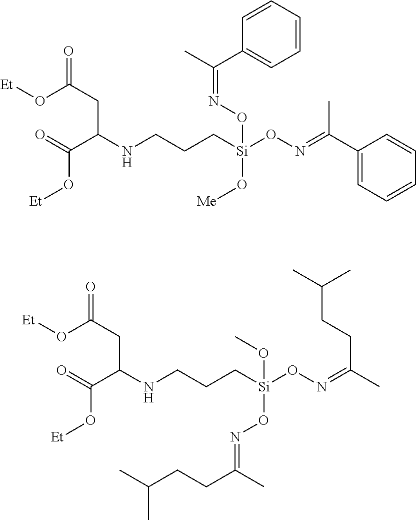 [SMILES: CCOC(=O)CC(NCCC[Si](OC)(O/N=C(/C)c1ccccc1)O/N=C(\C)c1ccccc1)C(=O)OCC ; CCOC(=O)CC(NCCC[Si](OC)(O/N=C(/C)CCC(C)C)O/N=C(\C)CCC(C)C)C(=O)OCC]

The present invention also relates to a process for preparing a compound of formula (I) as defined above, comprising the reaction between a compound of formula (II) below:

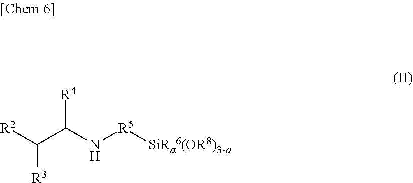

wherein:
R², R³, R⁴, R⁵, R⁶ and a are as defined above in formulae (I), (I-1), (I-2), (I-3); and
R⁸ represents an alkyl radical or an acyl radical comprising from 1 to 8 carbon atoms, preferentially from 1 to 3 carbon atoms;
   with a compound of formula (III) below:

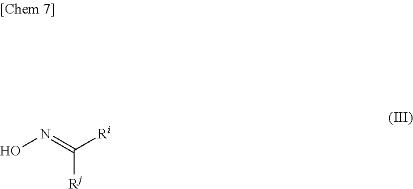

wherein Rⁱ and R^{j} are as defined above.

The reaction may be performed at a temperature ranging from 0° C. to 100° C., preferably from 23° C. to 80° C.

The compound of formula (II):compound of formula (III) mole ratio (r3) can vary from 1:0.1 to 1:3, and preferably from 1:1 to 1:3; even more preferentially it is equal to 1:1.

The reaction can take place in the presence or absence of solvent, preferably in the absence of solvent.

The reaction can take place in the presence or absence of plasticizer, preferably in the absence of plasticizer.

Among the compounds of abovementioned formula (III), mention may for example be made of:
the compounds of formula (III-1) wherein:
   Rⁱ is a linear or branched alkyl radical comprising from 1 to 4 carbon atoms;
   Rⁱ represents a linear or branched alkyl radical comprising from 1 to 8 carbon atoms, preferably from 1 to 6 carbon atoms, more preferably from 1 to 5 carbon atoms;
the compounds of formula (III-2) wherein:
   Rⁱ is a linear or branched alkyl radical comprising from 1 to 4 carbon atoms;
   Rⁱ represents a phenyl radical, or a radical —CH₂—N(G¹G²) where G¹ and G² represent, independently of one another, preferably a methyl, ethyl, propyl, butyl, pentyl or benzyl (—CH₂—C₆H₅) radical, more preferably a methyl, ethyl, propyl or benzyl group;
the compounds of formula (III-3) wherein R^{j} and Rⁱ together form an aliphatic ring comprising from 5 to 12 carbon atoms, preferably 6 carbon atoms, said aliphatic ring being optionally substituted with at least one alkyl radical comprising from 1 to 4 carbon atoms, and said ring optionally comprising one or more heteroatoms selected from an oxygen atom, a sulfur atom or a nitrogen atom, said nitrogen atom then not being bonded to a hydrogen atom.

Among the compounds of abovementioned formula (III-1), mention may for example be made of 2-butanone oxime, methyl isobutyl ketoxime, 5-methyl-2-hexanone oxime.

Among the compounds of abovementioned formula (III-2), mention may for example be made of benzaldehyde oxime, or acetophenone, or else the compound of the following formula:

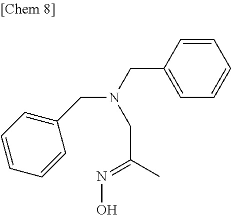 [SMILES: C/C(CN(Cc1ccccc1)Cc1ccccc1)=N\O]

Among the compounds of abovementioned formula (III-1), mention may for example be made of cyclohexanone oxime or cyclododecanone oxime. These two compounds are widely commercially available. Thus, cyclohexanone oxime may be obtained from the company OMG Borchers under the trade name Borchi® NOX C3.

The compounds of formula (II) are preferably chosen from the compounds of formulae (II-1), (II-2) and (II-3) below:

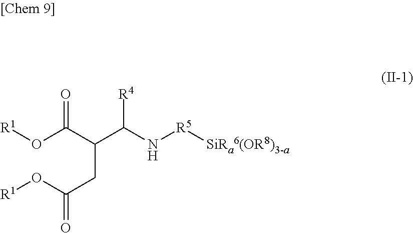

wherein a, R¹, R⁵, R⁶ and R⁸ are as defined above, and R⁴ represents H;

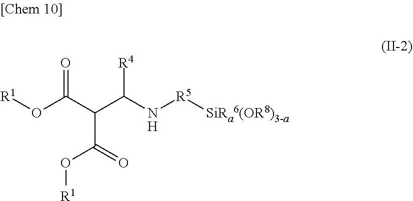

wherein a, R¹, R⁵, R⁶ and R⁸ are as defined above, and R⁴ represents H;

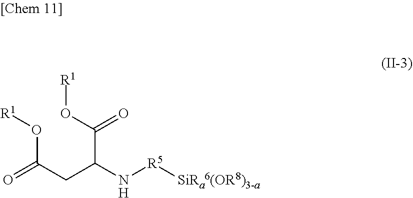

wherein a, R¹, R⁵, R⁶ and R⁸ are as defined above.

Preferably, in the abovementioned formulae (II), (II-1), (II-2) and (II-3), R⁸ represents an alkyl radical comprising 1 or 2 carbon atoms.

Preferably, in the formulae (II), (II-1), (II-2) and (II-3), each R¹, which may be identical or different, represents, independently of one another, a linear or branched alkyl group comprising from 1 to 12 carbon atoms, preferentially from 1 to 8 carbon atoms, and even more preferentially from 1 to 5 carbon atoms.

The compounds of formula (II) may be obtained via a process comprising the reaction between a compound of formula (IV) below:

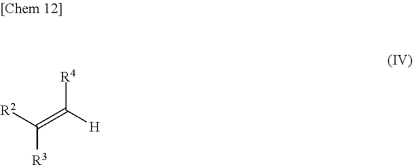

wherein R², R³ and R⁴ are as defined above;
and a compound of formula (V) below:

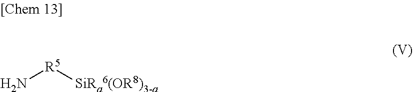

wherein a, R⁶, R⁵, R⁸ and a are as defined above.

The reaction may be performed at a temperature ranging from 0° C. to 100° C., preferably from 23° C. to 80° C.

The compound of formula (IV):compound of formula (V) mole ratio is preferably equal to 1:1.

The reaction can take place in the presence or absence of solvent, preferably in the absence of solvent.

The reaction can take place in the presence or absence of plasticizer, preferably in the absence of plasticizer.

The compounds of formula (IV) may be chosen from methyl acrylate, ethyl acrylate, butyl acrylate, 2-ethylhexyl acrylate, isooctyl acrylate, isodecyl acrylate, lauryl acrylate, ethoxylated (4EO) lauryl acrylate, propoxylated (4PO) lauryl acrylate, isotridecyl acrylate, stearyl acrylate, behenyl acrylate, 2-(2-ethoxyethoxy)ethyl acrylate, tetrahydrofurfuryl acrylate, 2-phenoxyethyl acrylate, 3,3,5-trimethylcyclohexyl acrylate, methylacrylamide, dibutylacrylamide, methyl methacrylate, ethyl methacrylate, butyl methacrylate, 2-ethylhexyl methacrylate, isooctyl methacrylate, isobornyl acrylate, glycerol formal acrylate, trimethylolpropane formal acrylate, isodecyl methacrylate, lauryl methacrylate, ethoxylated (4EO) lauryl methacrylate, propoxylated (4PO) lauryl methacrylate, isotridecyl methacrylate, stearyl methacrylate, behenyl methacrylate, 2-(2-ethoxyethoxy)ethyl methacrylate, tetrahydrofurfuryl methacrylate, 2-phenoxyethyl methacrylate, ethoxylated (4EO) phenyl methacrylate, 3,3,5-trimethylcyclohexyl methacrylate, isobornyl methacrylate, glycerol formal methacrylate, trimethylolpropane formal methacrylate, methylmethacrylamide, dibutylmethacrylamide, diethyl itaconate, dimethyl itaconate, dibutyl itaconate, dioctyl itaconate, methyl cinnamate, vinyl phosphate, diethyl maleate, dibutyl maleate, dioctyl maleate, dimethyl maleate, dimethyl fumarate, dimethyl methylenemalonate, diethyl methylenemalonate, dibutyl methylenemalonate, dioctyl methylenemalonate and mixtures thereof. Preferably, the compound of formula (IV) is diethyl maleate.

The compounds of abovementioned formula (V) are preferably chosen from 3-aminopropyltriethoxysilane, 2-aminoethyldimethylmethoxysilane, 3-aminopropyltrimethoxysilane, 3-aminopropylmethyldiethoxysilane, 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, analogues thereof with ethoxy or isopropoxy groups in the place of the methoxy groups on the Si atom, and mixtures thereof.

### B. Silylated Polymers

The present invention also relates to the use of the compounds of formula (I) for the preparation of silylated polymers, and more particularly of silylated polyurethanes.

The present invention relates to a silylated polyurethane P comprising at least one end function of formula (VI) below:

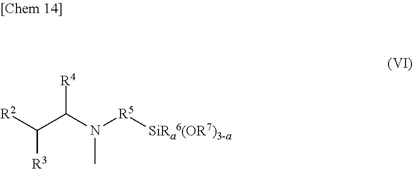

wherein:
R² is a radical selected from the group consisting of —C(O)OR¹, —C(O)NH₂, —CONHR¹,
—C(O)N(R¹)₂, —CN, —NO₂, —PO(OR¹)₂, —SO₂R¹ and —SO₂OR¹;
R³ is a radical selected from the group consisting of a hydrogen atom, —CH₃, —R¹, —C(O)OR¹ and —CH₂C(O)OR¹;
R⁴ is a radical selected from the group consisting of a hydrogen atom, —R¹, —C(O)OR¹ and —CN;
R¹ represents an organic radical comprising from 1 to 20 carbon atoms, optionally comprising at least one heteroatom such as for example O;
R⁵ is a linear or branched divalent alkylene radical comprising from 1 to 12 carbon atoms;
R⁶ is a linear or branched alkyl group comprising from 1 to 8 carbon atoms, or an alkoxy group comprising from 1 to 8 carbon atoms;
R⁷ is a group —N═C(Rⁱ)Rⁱ wherein:
   Rⁱ is a radical selected from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   Rⁱ is a radical selected from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
   or Rⁱ and R^{j} together form an aliphatic ring comprising from 3 to 14 carbon atoms, preferably from 4 to 8 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom;
a is an integer equal to 0, 1 or 2, preferably equal to 0 or 1.

According to one preferred embodiment, the polyurethane is the one for which, in the abovementioned formula (VI), R¹ represents a linear or branched alkyl group comprising from 1 to 20 carbon atoms, preferably from 1 to 10 carbon atoms, and even more preferentially from 1 to 5 carbon atoms.

Preferably, in the compounds of abovementioned formula (VI):
R² is a radical —C(O)OR¹; and/or
R³ is a radical selected from the group consisting of a hydrogen atom, —C(O)OR¹ and —CH₂C(O)OR¹; and/or
R⁴ is a hydrogen atom or —C(O)OR¹;
   R¹ preferably representing a linear or branched alkyl group comprising from 1 to 20 carbon atoms, preferably from 1 to 10 carbon atoms, and even more preferentially from 1 to 5 carbon atoms.

More preferably, in the compounds of abovementioned formula (VI):
R² is a radical —C(O)OR¹; and
R³ is a radical selected from the group consisting of a hydrogen atom, —C(O)OR¹ and —CH₂C(O)OR¹; and R⁴ is a hydrogen atom or —C(O)OR¹;
   R¹ representing a linear or branched alkyl group comprising from 1 to 20 carbon atoms, preferably from 1 to 10 carbon atoms, and even more preferentially from 1 to 5 carbon atoms.

The abovementioned polyurethanes P preferably have at least one end function of formula (VI-1), (VI-2) or (VI-3) below:

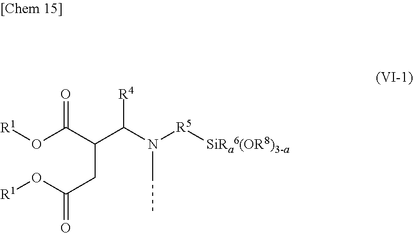

wherein a, R¹, R⁶, R⁷ and R⁵ are as defined above, and R⁴ represents H;

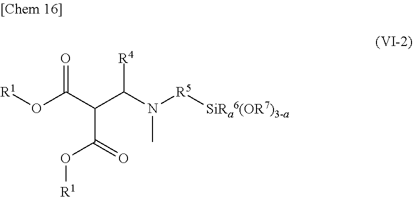

wherein a, R¹, R⁵, R⁶ and R⁷ are as defined above, and R⁴ represents H;

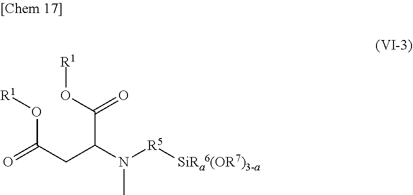

wherein a, R¹, R⁵, R⁶ and R⁷ are as defined above.

Preferably, in the abovementioned formulae (VI), (VI-1), (VI-2) and (VI-3):
each R¹, which may be identical or different, represents, independently of one another, a linear or branched alkyl group comprising from 1 to 12 carbon atoms, preferentially from 1 to 8 carbon atoms, and even more preferentially from 1 to 5 carbon atoms; and
R⁴ represents a hydrogen atom; and
R⁵ represents a linear or branched divalent alkylene radical comprising from 1 to 6 carbon atoms, preferentially 3 carbon atoms.

According to one embodiment, in the formulae (VI), (VI-1), (VI-2) and (VI-3):
Rⁱ represents a hydrogen atom, or a linear or branched alkyl radical comprising from 1 to 10 carbon atoms such as, for example, a methyl; and/or
Rⁱ represents a linear or branched alkyl radical comprising from 1 to 8 carbon atoms, preferably from 1 to 6 carbon atoms, more preferably from 1 to 5 carbon atoms, or a phenyl radical, or a radical —CH₂—N(G¹G²) where G¹ and G² represent, independently of one another, preferably a methyl, ethyl, propyl, butyl, pentyl or benzyl (—CH₂—C₆H₅) radical, more preferably a methyl, ethyl, propyl or benzyl radical.

According to one embodiment, in formulae (VI), (VI-1), (VI-2) and (VI-3), Rⁱ and R^{j} together form an aliphatic ring comprising from 5 to 12 carbon atoms, preferably 6 carbon atoms, said aliphatic ring being optionally substituted with at least one alkyl radical comprising from 1 to 4 carbon atoms, and said ring optionally comprising one or more heteroatoms selected from an oxygen atom, a sulfur atom or a nitrogen atom, said nitrogen atom then not being bonded to a hydrogen atom. Preferably, the ring is neither substituted nor comprises a heteroatom.

The polyurethanes P are preferably those for which, in the abovementioned formulae (VI), (VI-1), (VI-2) and (VI-3) are preferably those for a, R¹, R², R³, R⁵, R⁶, R⁴ are as defined above and R⁷ is a group —N═C(Rⁱ)Rⁱ wherein:
Rⁱ is a linear or branched alkyl radical comprising from 1 to 4 carbon atoms;
Rⁱ represents a linear or branched alkyl radical comprising from 1 to 8 carbon atoms, preferably from 1 to 6 carbon atoms, more preferably from 1 to 5 carbon atoms, or a phenyl radical.

The polyurethanes P are preferably polymers having at least one end function of abovementioned formula (VI-1).

The polyurethane P can be obtained via a process comprising a step of reaction between:
at least one compound of formula (I) as defined above, and
a polyurethane prepolymer of formula (VII) below:

[Chem 18]

B [symbol] NCO]ᵣ (VII)

with r representing an integer or non-integer number which may range from 2 to 4, and

B representing a multivalent organic radical.

The polyurethane P can also be obtained via a process comprising a step of reaction between:
a compound of formula (III) as defined above;
a compound of formula (II) as defined above;
a polyurethane prepolymer of formula (VII) below:

[Chem 19]

B [symbol] NCO]ᵣ (VII)

with r representing an integer or non-integer number which may range from 2 to 4, and B representing a multivalent organic radical.

The prepolymer of formula (VII) may be obtained via any method known to those skilled in the art for the preparation of an NCO-terminated prepolymer.

According to one embodiment, the abovementioned prepolymer of formula (VII) is a polyurethane obtained by a polyaddition reaction:
a) of at least one polyisocyanate preferably chosen from diisocyanates, triisocyanates, and mixtures thereof;
b) with at least one polyol, preferably chosen from polyether polyols, polycarbonate polyols, polyester polyols, and mixtures thereof;
in amounts such that the NCO/OH mole ratio (r1) is strictly greater than 1, preferably ranges from 1.2 to 2.0.

According to one embodiment, the polyurethane P according to the invention is prepared via a process comprising the following steps:
E1) the preparation of an NCO-terminated polyurethane prepolymer of the abovementioned formula (VII) via a polyaddition reaction:
   i) of at least one polyisocyanate, preferably chosen from diisocyanates, triisocyanates and their mixtures;
   ii) with at least one polyol, preferably chosen from polyether polyols, polycarbonate polyols, polyester polyols, and mixtures thereof;
   in amounts such that the NCO/OH mole ratio (r1) is strictly greater than 1; and
E2) the reaction of the product formed on conclusion of step E1) with at least one compound of formula (I) as defined previously,

in particular in amounts such that the NCO/NH mole ratio (r2) is preferably between 0.8 and 1.2, preferably between 0.9 and 1.1, and preferentially close to 1;

or

E′2) the reaction of the product formed on conclusion of step E1) with at least one compound of formula (II) and at least one compound of formula (III) as defined previously, in particular in amounts such that:
the NCO/NH mole ratio (r2) is preferably between 0.8 and 1.2, preferably between 0.9 and 1.1, and preferentially close to 1; and that
the compound of formula (II):compound of formula (III) mole ratio (r3) ranges from 1:0.1 to 1:3, and preferably from 1:1 to 1:3, and even more preferentially equal to 1:1.

In the context of the invention, and unless otherwise mentioned, (r1) is the NCO/OH mole ratio corresponding to the mole ratio of the number of isocyanate (NCO) groups to the number of hydroxyl (OH) groups borne by all of the polyisocyanate(s) and polyol(s) present in the reaction medium of step E1).

In the context of the invention, and unless otherwise mentioned, (r2) is the NCO/NH mole ratio corresponding to the mole ratio of the number of isocyanate groups to the number of —NH— groups borne, respectively, by all of the isocyanate(s) (as notably regards the NCO-terminated polyurethane prepolymer and optionally the polyisocyanate(s) which have not reacted at the end of step E1)), and compound(s) of formula (I) present in the reaction medium of step E2).

In the context of the invention, and unless otherwise stated, (r3) is the mole ratio corresponding to the compound of formula (II):compound of formula (III) mole ratio.

When the polyurethane of formula (VII) is obtained during step E1) from a mixture of polyisocyanates or of several polyisocyanates added successively, the calculation of the ratio (r1) takes into account firstly the NCO groups borne by all of the polyisocyanates present in the reaction medium of step E1), and secondly the OH groups borne by the polyol(s) present in the reaction medium of step E1).

During step E1), the polyaddition reaction is performed at a temperature preferably below 95° C., and preferably under anhydrous conditions. Step E1)

The polyol(s) that can be used to prepare the prepolymer of abovementioned formula (VII) used according to the invention may be chosen from those for which the number-average molecular mass (Mn) ranges from 300 to 30 000 g/mol, preferably from 400 to 20 000 g/mol and preferentially from 500 to 12 000 g/mol.

Preferably, their hydroxyl functionality ranges from 2 to 3. The hydroxyl functionality is the mean number of hydroxyl functions per mole of polyol.

The polyol(s) that can be used according to the invention may have a (mean) hydroxyl number (IOH) ranging from 3 to 570 milligrams of KOH per gram of polyol (mg KOH/g), preferably from 5 to 430 mg KOH/g, more preferably from 9 to 340 mg KOH/g.

The polyol(s) may be chosen from polyether polyols, polyester polyols, polycarbonate polyols, and mixtures thereof. Preferably, step E1) is carried out with a polyether polyol.

The polyether polyol(s) that may be used according to the invention is (are) preferably chosen from polyoxyalkylene polyols, the linear or branched alkylene portion of which comprises from 2 to 4 carbon atoms, more preferentially from 2 to 3 carbon atoms.

More preferentially, the polyether polyol(s) that may be used according to the invention is (are) preferably chosen from polyoxyalkylene-diols or polyoxyalkylene triols, the linear or branched alkylene portion of which comprises from 1 to 4 carbon atoms, more preferentially from 2 to 3 carbon atoms.

As examples of polyoxyalkylene diols or triols that can be used according to the invention, mention may be made of:
polyoxypropylene diols or triols (also denoted by polypropylene glycol (PPG) diols or triols) having a number-average molecular mass (Mn) ranging from 300 to 20 000 g/mol;
polyoxyethylene diols or triols (also denoted by polyethylene glycol (PEG) diols or triols) having a number-average molecular mass (Mn) ranging from 300 to 15 000 g/mol;
polyoxybutylene diols or triols (also denoted by (PBG) diols or triols) having a number-average molecular mass ranging from 300 to 20 000 g/mol;
polytetramethylene diols or triols (also denoted by polyTHF or PTMEG) having a number-average molecular mass (Mn) ranging from 300 to 4000 g/mol;
diol or triol copolymers or terpolymers based on ethylene oxide, propylene oxide and/or butylene oxide having a number-average molecular mass (Mn) ranging from 300 to 4000 g/mol;
and mixtures thereof.

The abovementioned polyether polyols may be prepared conventionally and are widely available commercially. They can be obtained by polymerization of the corresponding alkylene oxide in the presence of a basic catalyst (for example potassium hydroxide) or of a catalyst based on a double metal/cyanide complex.

Among the polypropylene glycols with a hydroxyl functionality equal to 2, mention may be made of:
Voranol® EP 1900: difunctional PPG with a number-average molecular mass of about 4008 g/mol, and a hydroxyl number I_{OH} equal to 28 mg KOH/g;
Acclaim® 8200: difunctional PPG with a number-average molecular mass of 8016 g/mol, and a hydroxyl number I_{OH} equal to 14 mg KOH/g;
Acclaim® 12200: difunctional PPG with a number-average molecular mass of 11 222 g/mol, and a hydroxyl number I_{OH} equal to 10 mg KOH/g;
Acclaim® 18200: difunctional PPG with a number-average molecular mass of 17 265 g/mol, and a hydroxyl number I_{OH} equal to 6.5 mg KOH/g.

Among the polypropylene glycols with a hydroxyl functionality equal to 3, mention may be made of:
Voranol® CP 755: trifunctional PPG with a number-average molecular mass of about 710 g/mol, and a hydroxyl number IOH equal to 237 mg KOH/g;
Voranol® CP 3355: trifunctional PPG with a number-average molecular mass of about 3544 g/mol, and a hydroxyl number I_{OH} equal to 47.5 mg KOH/g;
Acclaim® 6300: trifunctional PPG with a number-average molecular mass of about 5948 g/mol, and a hydroxyl number I_{OH} equal to 28.3 mg KOH/g.

Among the polytetramethylene glycols with a hydroxyl functionality equal to 2, mention may be made of:
Terathane® PTMEG 250: difunctional PolyTHF with a number-average molecular mass of about 4008 g/mol, and a hydroxyl number I_{OH} ranging from 230 to 270 mg KOH/g;
Terathane® PTMEG 2900: difunctional PolyTHF with a number-average molecular mass of about 4008 g/mol, and a hydroxyl number I_{OH} ranging from 37.7 to 39.7 mg KOH/g.

In the context of the invention, the term “hydroxyl functionality of a polyether polyol” means the mean number of hydroxyl functions per mole of polyether polyol.

The polyester polyols can be chosen from polyester diols and polyester triols, and preferably from polyester diols.

Examples of polyester diols or triols that may be mentioned include:
Realkyd® XTR 10410 sold by the company Cray Valley, with a number-average molecular mass (Mn) in the region of 1000 g/mol and the hydroxyl number of which ranges from 108 to 116 mg KOH/g. It is a product resulting from the condensation of adipic acid, diethylene glycol and monoethylene glycol;
the polycaprolactone diols or triols sold by the company Perstorp under the reference CAPA Polyols, having a number-average molecular mass (Mn) ranging from 240 to 8000 g/mol.

The polycarbonate polyols may be chosen from polycarbonate diols or triols, in particular with a number-average molecular mass (Mₙ) ranging from 300 g/mol to 12 000 g/mol.

Examples of polycarbonate diols that may be mentioned include:
Converge Polyol 212-10 and Converge Polyol 212-20 sold by Novomer, with respective number-average molecular masses (Mₙ) equal to 1000 and 2000 g/mol, the hydroxyl numbers of which are, respectively, 112 and 56 mg KOH/g,
Desmophen® C XP 2716, sold by Covestro, with a number-average molecular mass (Mₙ) equal to 326 g/mol, and the hydroxyl number of which is 344 mg KOH/g,
Polyol C-590, C1090, C-2090 and C-3090 sold by Kuraray, with a number-average molecular mass (Mₙ) ranging from 500 to 3000 g/mol and a hydroxyl number ranging from 224 to 37 mg KOH/g.

The polyisocyanate(s) that can be used to prepare the prepolymer of the abovementioned formula (VII) may be added sequentially or reacted in the form of a mixture.

According to one embodiment, the polyisocyanate(s) that can be used are diisocyanate(s), preferably chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, 4,4′-methylenebis(cyclohexyl isocyanate) (4,4′-HMDI), norbornane diisocyanate, norbornene diisocyanate, 1,4-cyclohexane diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 1,5-diisocyanato-2-methylpentane (MPDI), 1,6-diisocyanato-2,4,4-trimethylhexane, 1,6-diisocyanato-2,2,4-trimethylhexane (TMDI), 4-isocyanatomethyl-1,8-octane diisocyanate (TIN), 2,5-bis(isocyanatomethyl)bicyclo[2.2.1]heptane (2,5-NBDI), 2,6-bis(isocyanatomethyl)bicyclo[2.2.1]heptane (2,6-NBDI), 1,3-bis(isocyanatomethyl)cyclohexane (1,3-H6-XDI), 1,4-bis(isocyanatomethyl)cyclohexane (1,4-H6-XDI), xylylene diisocyanate (XDI) (in particular m-xylylene diisocyanate (m-XDI)), toluene diisocyanate (in particular 2,4-toluene diisocyanate (2,4-TDI) and/or 2,6-toluene diisocyanate (2,6-TDI)), diphenylmethane diisocyanate (in particular 4,4′-diphenylmethane diisocyanate (4,4′-MDI) and/or 2,4′-diphenylmethane diisocyanate (2,4′-MDI)), tetramethylxylylene diisocyanate (TMXDI) (in particular tetramethyl-meta-xylylene diisocyanate), and mixtures thereof.

Preferably, the polyisocyanate(s) is (are) chosen from toluene diisocyanate (in particular the isomer 2,4-TDI, the isomer 2,6-TDI or mixtures thereof), meta-xylylene, IPDI, and mixtures thereof. Preferably, the polyisocyanate is isophorone diisocyanate (IPDI).

The polyisocyanate(s) which can be used are typically widely available commercially. By way of example, mention may be made of Scuranate® TX sold by the company Vencorex, corresponding to a 2,4-TDI having a purity of the order of 95%, Scuranate® T100 sold by the company Vencorex, corresponding to a 2,4-TDI having a purity of greater than 99% by weight, Desmodur® I sold by the company Covestro, corresponding to an IPDI or else Desmodur® N3300 sold by the company Covestro, corresponding to an HDI isocyanate, Takenate™ 500 sold by Mitsui Chemicals, corresponding to an m-XDI, Takenate™ 600 sold by Mitsui Chemicals, corresponding to an m-H6XDI, Vestanat® H12MDI sold by Evonik, corresponding to an H12MDI.

Preferably, the polyisocyanate is isophorone diisocyanate (IPDI).

The polyaddition reaction of step E1) can be carried out in the presence or absence of at least one reaction catalyst.

The reaction catalyst(s) which can be used during the polyaddition reaction of step E1) can be any catalyst known to a person skilled in the art for catalyzing the formation of polyurethane by reaction of at least one polyisocyanate with at least one polyol.

An amount ranging up to 0.3% by weight of catalyst(s), relative to the weight of the reaction medium of step E1), may be used. In particular, it is preferable to use from 0.02% to 0.2% by weight of catalyst(s) relative to the total weight of the reaction medium of step E1).

Steps E2) and E′2)

Steps E2) and E′2) may be carried out under anhydrous conditions.

Steps E2) and E′2) may be carried out at a temperature ranging from 40° C. to 100° C., preferably from 60° C. to 100° C.

Steps E2) and E′2) may be carried out in the presence or absence of at least one reaction catalyst.

The reaction catalyst(s) that can be used during the polyaddition reaction of step E2) (or E′2)) may be any catalyst known to a person skilled in the art for catalyzing this type of reaction.

An amount ranging up to 0.3% by weight of catalyst(s) relative to the weight of the reaction medium of step E2) (or E′2)) may be used. In particular, it is preferred to use from 0.02% to 0.2% by weight of catalyst(s) relative to the total weight of the reaction medium of step E2) (or E′2)).

Preferably, no catalyst is used for steps E2) and E′2).

The prepolymer of formula (VII) may comprise a mass content of NCO groups ranging from 0.1% to 15%, preferably from 0.2% to 10%, preferentially from 0.5% to 8% and advantageously from 0.6% to 3% relative to the total mass of said prepolymer.

The present invention notably relates to a polyurethane P′ having the formula (VIII) below:

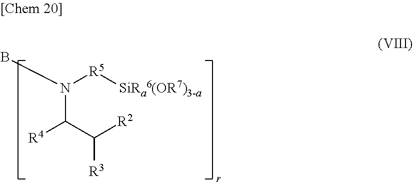

wherein:
B represents a multivalent organic radical;
r represents an integer or non-integer number ranging from 2 to 4;
a, R², R³, R⁴, R⁵, R⁶, and R⁷ are as defined above.

Each occurrence of each one from among a, R¹, R², R³, R⁴, R⁵, R⁶, and R⁷ may be identical or different in each repeating unit. For example, when r=2, there are two repeating units that may be identical or different. For example, when r=3, there are three repeating units that may be identical or different.

The polyurethane P′ may be a particular example of the abovementioned polymer P.

The polyurethane P preferably has the formula (IX) below:

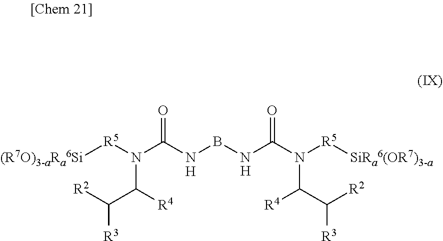

wherein:
B represents a multivalent organic radical;
a, R², R³, R⁴, R⁵, R⁶, and R⁷ are as defined above.

Each occurrence of each one from among a, R¹, R², R³, R⁴, R⁵, R⁶, and R⁷ may be identical or different.

The term “each occurrence of each one from among a, R¹, R², R³, R⁴, R⁵, R⁶, and R⁷, which may be identical or different” means, for example, that each occurrence of R¹ in formula (IX) may be identical or different, or else that each occurrence of a may be identical or different in formula (IX). This is likewise the case for all the radicals mentioned.

According to one embodiment, in formula (IX) above, each occurrence of each one from among a, R¹, R², R³, R⁴, R⁵, R⁶, and R⁷ is identical.

The polyurethane P according to the invention preferably has one of the formulae (X), (XI) or (XII) below:

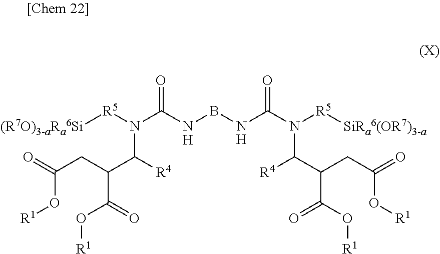

wherein a, R¹, R⁵, R⁶ and R⁷ are as defined above, and R⁴ represents H;

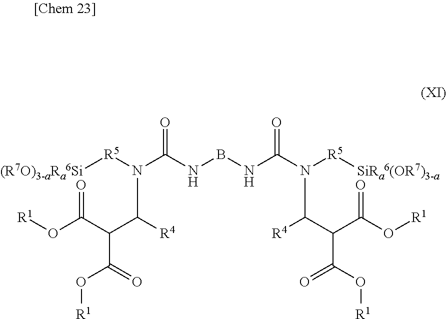

wherein a, R¹, R⁵, R⁶ and R⁷ are as defined above, and R⁴ represents H;

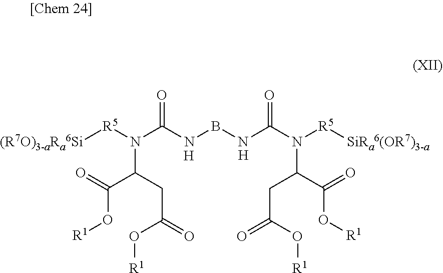

wherein a, R¹, R⁵, R⁶ and R⁷ are as defined above.

According to one embodiment, the polyurethanes P′ of the abovementioned formulae (VIII), (IX), (X), (XI) and (XII) are those for which:
each R¹, which may be identical or different, represents, independently of one another, a linear or branched alkyl group comprising from 1 to 12 carbon atoms, preferentially from 1 to 8 carbon atoms, and even more preferentially from 1 to 5 carbon atoms; and
R⁴ represents a hydrogen atom; and
R⁵ represents a linear or branched divalent alkylene radical comprising from 1 to 6 carbon atoms, preferentially 3 carbon atoms.

According to one embodiment, in formulae (VIII), (IX), (X), (XI) and (XII):
Rⁱ represents a hydrogen atom, or a linear or branched alkyl radical comprising from 1 to 10 carbon atoms such as, for example, a methyl; and/or
Rⁱ represents a linear or branched alkyl radical comprising from 1 to 8 carbon atoms, preferably from 1 to 6 carbon atoms, more preferably from 1 to 5 carbon atoms, or a phenyl radical, or a radical —CH₂—N(G¹G²) where G¹ and G² represent, independently of one another, preferably a methyl, ethyl, propyl, butyl, pentyl or benzyl (—CH₂—C₆H5) radical, more preferably a methyl, ethyl, propyl or benzyl radical.

According to one embodiment, in formulae (VIII), (IX), (X), (XI) and (XII), Rⁱ and R^{j} together form an aliphatic ring comprising from 5 to 12 carbon atoms, preferably 6 carbon atoms, said aliphatic ring being optionally substituted with at least one alkyl radical comprising from 1 to 4 carbon atoms, and said ring optionally comprising one or more heteroatoms selected from an oxygen atom, a sulfur atom or a nitrogen atom, said nitrogen atom then not being bonded to a hydrogen atom. Preferably, the ring is neither substituted nor comprises a heteroatom.

The polyurethanes P′ of abovementioned formulae (VIII), (IX), (X), (XI) and (XII) are preferably those for which a, R¹, R², R³, R⁵, R⁶ are as defined above and R⁷ is a group —N═C(Rⁱ)Rⁱ wherein:
Rⁱ is a linear or branched alkyl radical comprising from 1 to 4 carbon atoms;
Rⁱ represents a linear or branched alkyl radical comprising from 1 to 8 carbon atoms, preferably from 1 to 6 carbon atoms, more preferably from 1 to 5 carbon atoms, or a phenyl radical.

The present invention also relates to the use of the abovementioned polyurethanes (P and P′) for the preparation of adhesives, sealants or coatings.

The silylated polyurethanes according to the invention advantageously have a lower viscosity than existing silylated polyurethanes, which makes them easier to handle and to use. This also advantageously makes it possible not to have to use plasticizers and/or solvents during their synthesis or during the preparation of formulations.

The silylated polyurethanes according to the invention advantageously have a lower viscosity than existing silylated polyurethanes while retaining good adhesive bonding properties.

The silylated polyurethanes according to the invention advantageously have a high elongation at break, which makes them useful for applications in construction, for example.

The silylated polyurethanes according to the invention advantageously make it possible to reduce or even prevent the release of methanol.

### C. Formulations

The present invention relates to a formulation comprising at least one polyurethane P or P according to the invention, and at least one additive chosen from the group consisting of catalysts, fillers, antioxidants, light stabilizers/UV absorbers, metal deactivators, antistatic agents, foaming agents, biocides, plasticizers, lubricants, emulsifiers, dyes, pigments, rheological agents, impact modifiers, adhesion promoters, optical brighteners, flame retardants, anti-sweating agents, nucleating agents, solvents, reactive diluents and mixtures thereof.

The fillers usually used are, for example, inorganic or organic powders, for example calcium carbonates and silicates, and inorganic fibrous materials, for example glass fibers. It is also possible to use organic fillers such as carbon fibers, mixtures of organic and inorganic fillers, for example mixtures of glass fibers and of carbon fibers or mixtures of carbon fibers and of inorganic fillers. The fillers may be added in an amount ranging from 1% to 75% by weight, relative to the total weight of the formulation.

The UV stabilizers, the antioxidants and the metal deactivators used in the formulations according to the invention advantageously have good migration resistance and high thermal stability. They are chosen, for example, from the following groups a) to t). The compounds of groups a) to g) and i) are light stabilizers/UV absorbers, whereas compounds j) to t) act as stabilizers:
a) 4,4-diarylbutadienes,
b) cinnamic esters,
c) benzotriazoles,
d) hydroxybenzophenones,
e) diphenyl cyanoacrylates,
f) oxamides,
g) 2-phenyl-1,3,5-triazines,
h) antioxidants,
i) nickel derivatives,
j) sterically hindered amines,
k) metal deactivators,
I) phosphites and phosphonites,
m) hydroxylamines,
n) nitrones,
o) amine oxides,
p) benzofuranones and indolinones,
q) thiosynergists,
r) peroxide destroyers,
s) polyamide stabilizers and
t) basic co-stabilizers.

The crosslinking catalysts are optionally used in proportions ranging from 0.01% to about 10% by weight, relative to the total weight of the formulation.

The crosslinking catalyst may be chosen from:
organotitanium derivatives, for instance titanium acetylacetonate (commercially available under the name Tyzor® AA75 from the company DuPont), Ti(OnBu)₄ (commercially available under the name Tyzor® TnBT from DoRF Ketal);
organoaluminum derivatives, for instance aluminum chelate (commercially available under the name K-KAT® 5218 from the company King Industries);
organozinc derivatives, for instance Zn[O(C═O)C₉H₁₉]₂ (available from the company OMG Borchers under the trade name Borchi® KAT 15);
organobismuth derivatives, for instance Bi[O(C═O)C₉H₁₉]₂ (available from the company OMG Borchers under the trade name Borchi® KAT 315);
organotin derivatives, for instance dibutyltin dilaurate (or DBTL), dibutyltin dilaurate (DOTDL), dioctyltin bisacetylacetonate (available under the name Tibkat® 223) or Tibkat® 425 (which is a mixture of dioctyltin oxide and vinyltrimethoxysilane);
organic amines: preference is given to amidines, for example 1,8-diazabicyclo[5.4.0]undec-7-ene (DBU) and 1,5-diazabicyclo[4.3.0]non-5-ene (DBN), 1,5,7-triazabicyclo[4.4.0]dec-5-ene (TBD), di-o-tolylguanidine (DOTG), and C1 to C6 mono-, di- and trialkylamines, in particular triethylamine and tert-butylamine.

Preferably, the formulation does not include a tin-based catalyst, and even more preferably, it does not contain a crosslinking catalyst. The choice of the additives used advantageously depends on the final use made of the formulation according to the invention, the additives being able to be adjusted as a function of the application specifications by a person skilled in the art.

The formulation preferably comprises more than 20% by weight, advantageously more than 30% by weight of polyurethane P or P′ according to the invention relative to the total weight of said formulation.

The present invention also relates to the use of the abovementioned formulation for the preparation of adhesives, sealants or coatings.

All the embodiments described above may be combined with one another.

In the context of the invention, the term “between x and y” or “ranging from x to y” means a range wherein the limits x and y are included. For example, the range “between 0% and 25%” notably includes the values 0% and 25%.

The invention is now described in the following exemplary embodiments, which are given purely by way of illustration and should not be interpreted in order to limit the scope thereof.

### EXAMPLES

### Suppliers:

DEM: Diethyl maleate sold by Sigma-Aldrich;
Acclaim 12200: polypropylene glycol available from Covestro, having an IOH=11.0 mg KOH/g and an Mn=11 200 g/mol;
IPDI: isophorone diisocyanate (Mw=222.3 g/mol) sold by Covestro;
Borchi KAT 315: bismuth neodecanoate available from OMG Borchers;
TIBKAT 223: dioctyltin bis(acetylacetonate) sold by TIB Chemicals;
Silquest A-1110: 3-aminopropyltrimethoxysilane available from Momentive;
Silquest A-1100: 3-aminopropyltriethoxysilane available from Momentive;
Dynasylan 1122: bis(3-triethoxysilyl)propyl)amine sold by Evonik;
Dynasylan 1124: bis(3-trimethoxysilyl)propyl)amine sold by Evonik;
Dynasylan 1189: N-(3-(trimethoxysilyl)propyl)butylamine sold by Evonik;
GF9: N-(3-(trimethoxysilyl)propyl)ethylenediamine sold by Wacker;
Borchinox C3: cyclohexanone oxime sold by OMG Borchers;
Borchinox M2: 2-butanone oxime sold by OMG Borchers;
MIBKO: methyl isobutyl ketoxime sold by TCI Chemicals;
MHO: 5-methyl-2-hexanone oxime sold by TCI Chemicals;
BHO: benzaldehyde oxime sold by Sigma-Aldrich;
APO: acetophenone oxime sold by Sigma-Aldrich;
Mesamoll: alkyl sulfonate sold by LANXESS;
VTMO: vinyltrimethoxysilane sold by Sigma-Aldrich;
Calofort SV: precipitated calcium carbonate (average size 0.07 microns, stearate coated) sold by Specialty Minerals.

### Example 1: Preparation of Silylated Derivative S0

53.8 g of aminopropyltrimethoxysilane (A1110, 300 mmol) are introduced into a 250 ml reactor under nitrogen. DEM (300 mmol, 51.7 g) is then added dropwise to control the increase in temperature (exothermic reaction). The reaction is left at 70° C. for several hours until complete disappearance of the peak at 1626 cm⁻¹ (monitored by IR spectroscopy). Then, the reaction product is freed from volatile residues under reduced pressure in order to provide 103.1 g of silylated derivative S0 (slightly yellow liquid).

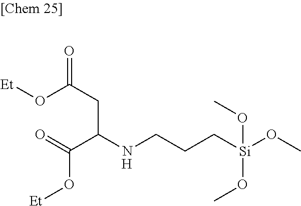

### Example 2: Preparation of Compound C1

17.6 g of silylated derivative S0 from example 1, and 8.7 g of 2-butanone oxime (100 mmol, 1/2 mole ratio) are introduced under nitrogen into a 50 ml reactor. The reaction is left at 23° C. for at least one hour until complete disappearance of the peak linked to the oximes between 3000 and 3200 cm⁻¹ (monitored by IR spectroscopy). Then, the reaction product is freed from volatile residues under reduced pressure in order to provide 23.1 g of compound C1.

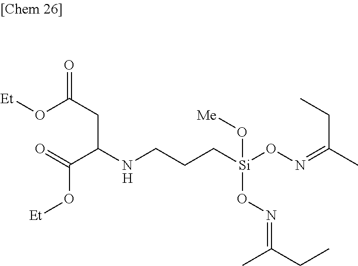

### Example 3: Preparation of Compound C2

17.6 g of silylated derivative S0 from example 1, and 13 g of 2-butanone oxime (150 mmol, 1/3 mole ratio) are introduced under nitrogen into a 50 ml reactor. The reaction is left at 23° C. for at least one hour until complete disappearance of the peak linked to the oximes between 3000 and 3200 cm⁻¹ (monitored by IR spectroscopy). Then, the reaction product is freed from volatile residues under reduced pressure in order to provide 25.8 g of compound C2.

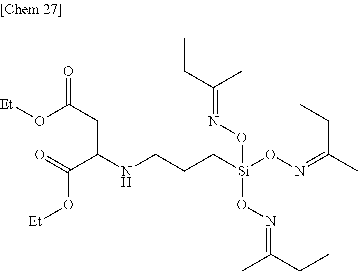 [SMILES: CCOC(=O)CC(NCCC[Si](O/N=C(/C)CC)(O/N=C(\C)CC)O/N=C(\C)CC)C(=O)OCC]

### Example 3: Preparation of Compound C3

17.6 g of silylated derivative S0 from example 1, and 11.5 g of methyl isobutyl ketoxime (MIBKO, 100 mmol, 1/2 mole ratio) are introduced under nitrogen into a 50 ml reactor. The reaction is left at 23° C. for at least one hour until complete disappearance of the peak linked to the oximes between 3000 and 3200 cm⁻¹ (monitored by IR spectroscopy). Then, the reaction product is freed from volatile residues under reduced pressure in order to provide 25.9 g of compound C3.

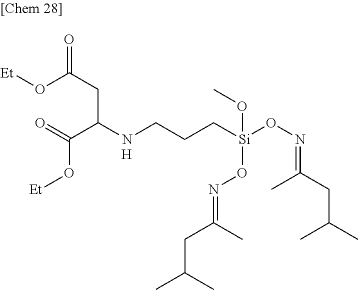

### Example 4: Preparation of Compound C4

17.6 g of silylated derivative S0 from example 1, and 17.3 g of methyl isobutyl ketoxime (MIBKO, 150 mmol, 1/3 mole ratio) are introduced under nitrogen into a 50 ml reactor. The reaction is left at 23° C. for at least one hour until complete disappearance of the peak linked to the oximes between 3000 and 3200 cm⁻¹ (monitored by IR spectroscopy). Then, the reaction product is freed from volatile residues under reduced pressure in order to provide 30 g of compound C4.

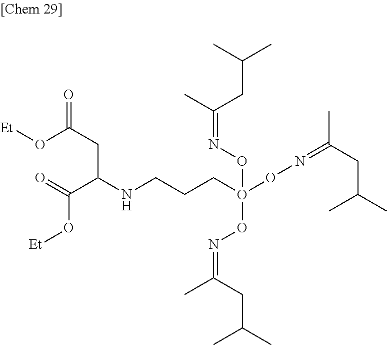

### Example 5: Preparation of Compound C5

17.6 g of silylated derivative S0 from example 1, and 13.5 g of acetophenone oxime (APO, 100 mmol, 1/2 mole ratio) are introduced under nitrogen into a 50 ml reactor. The reaction is left at 23° C. for at least one hour until complete disappearance of the peak linked to the oximes between 3000 and 3200 cm⁻¹ (monitored by IR spectroscopy). Then, the reaction product is freed from volatile residues under reduced pressure in order to provide 27.9 g of compound C5.

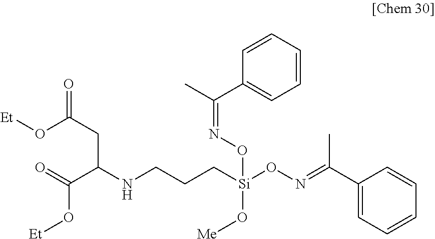 [SMILES: CCOC(=O)CC(NCCC[Si](OC)(O/N=C(/C)c1ccccc1)O/N=C(\C)c1ccccc1)C(=O)OCC]

### Example 6: Preparation of Compound C6

17.6 g of silylated derivative S0 from example 1, and 12.9 g of 5-methyl-2-hexanone oxime (MHO, 100 mmol, 1/2 mole ratio) are introduced under nitrogen into a 50 ml reactor. The reaction is left at 23° C. for at least one hour until complete disappearance of the peak linked to the oximes between 3000 and 3200 cm⁻¹ (monitored by IR spectroscopy). Then, the reaction product is freed from volatile residues under reduced pressure in order to provide 27.3 g of compound C6.

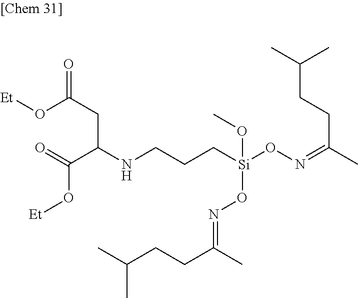 [SMILES: CCOC(=O)CC(NCCC[Si](OC)(O/N=C(/C)CCC(C)C)O/N=C(\C)CCC(C)C)C(=O)OCC]

### Example 7: Preparation of the NCO-Terminated Prepolymer (P0)

1367 g of Acclaim 12200 are introduced into a 2-liter reactor, and left under vacuum for 2 hours at 110° C. (water content≤0.02% by weight). The reactor is then cooled to 70° C. so as to introduce under a blanket of nitrogen 93.2 g of isophorone diisocyanate (IPDI) and 0.8 g of Borchi KAT 315 (bismuth neodecanoate available from OMG Borchers). The mixture is kept stirring until an NCO weight percentage of 1.7% is reached, i.e. 0.40 meq. NCO/g. 1460.2 g of NCO-terminated polyurethane prepolymer (P0) are obtained.

### Example 8: Preparation of Silylated Polymer P1 (Comparative)

100 g (40.4 mmol or 40.4 meq. NCO) of prepolymer (P0) and 14.8 g (42 mmol or 42 meq. NH₂) of the silylated derivative S0 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 114.8 g of silylated polyurethane (P1) are obtained, which product is packaged in aluminum cartridges protected from moisture.

### Example 9: Preparation of Silylated Polymer P2

100 g (40.4 mmol or 40.4 meq. NCO) of prepolymer (P0) and 19.4 g (42 mmol or 42 meq. NH₂) of the compound C1 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 114.8 g of silylated polyurethane (P2) are obtained, which product is packaged in aluminum cartridges protected from moisture.

### Example 10: Preparation of Silylated Polymer P3

100 g (40.4 mmol or 40.4 meq. NCO) of prepolymer (P0) and 21.7 g (42 mmol or 42 meq. NH₂) of the compound C2 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 121.7 g of silylated polyurethane (P3) are obtained, which product is packaged in aluminum cartridges protected from moisture.

### Example 11: Preparation of Silylated Polymer P4

100 g (40.4 mmol or 40.4 meq. NCO) of prepolymer (P0) and 21.75 g (42 mmol or 42 meq. NH₂) of the compound C3 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 121.75 g of silylated polyurethane (P4) are obtained, which product is packaged in aluminum cartridges protected from moisture.

### Example 12: Preparation of Silylated Polymer P5

100 g (40.4 mmol or 40.4 meq. NCO) of prepolymer (P0) and 25.2 g (42 mmol or 42 meq. NH₂) of the compound C4 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 125.2 g of silylated polyurethane (P5) are obtained, which product is packaged in aluminum cartridges protected from moisture.

### Example 13: Preparation of Silylated Polymer P6

100 g (40.4 mmol or 40.4 meq. NCO) of prepolymer (P0) and 23.4 g (42 mmol or 42 meq. NH₂) of the compound C5 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 123.4 g of silylated polyurethane (P6) are obtained, which product is packaged in aluminum cartridges protected from moisture.

### Example 14: Preparation of Silylated Polymer P7

100 g (40.4 mmol or 40.4 meq. NCO) of prepolymer (P0) and 22.9 g (42 mmol or 42 meq. NH₂) of the compound C6 in an NH/NCO mole ratio=1.04 are introduced under nitrogen into a 250 ml reactor. The mixture is heated to 70° C. and stirred until the band characteristic of the —NCO functions is no longer detectable by infrared spectroscopy. 122.9 g of silylated polyurethane (P7) are obtained, which product is packaged in aluminum cartridges protected from moisture.

### Example 15: Measurement of the Viscosities of Polymers P1 to P7

The viscosity of the silylated polymers P1 to P7 was measured using a Brookfield DV-I-Prime viscometer at 23° C.

The results are presented in the table below:

TABLE 1

| Silylated polymer | Viscosity at 23° C. (in mPa.s) |
|---|---|
| P1 (comparative) | 55 400 |
| P2 | 35 600 |
| P3 | 38 000 |
| P4 | 44 300 |
| P5 | 38 200 |
| P6 | 48 000 |
| P7 | 36 200 |

Thus, the silylated polymers P2 to P7 according to the invention advantageously have a lower viscosity than that of the silylated polymer P1 (comparative) (at 23° C.), which notably allows easier handling and use. In addition, a lower viscosity advantageously makes it possible to avoid the additional use of plasticizer/solvent in the formulations.

### Example 16: Preparation of Sealant Compositions

Sealants M1 to M7 were prepared by mixing the ingredients mentioned in the following table in a speed mixer at room temperature:

TABLE 2

| | M1 | | | | | | |
|---|---|---|---|---|---|---|---|
| | (comparative) | M2 | M3 | M4 | M5 | M6 | M7 |
| Polymer P1 | 41.8 | — | — | — | — | — | — |
| (comparative) | | | | | | | |
| P2 | — | 41.8 | — | — | — | — | — |
| P3 | — | — | 41.8 | — | — | — | — |
| P4 | — | — | — | 41.8 | — | — | — |
| P5 | — | — | — | — | 41.8 | — | — |
| P6 | — | — | — | — | — | 41.8 | — |
| P7 | — | — | — | — | — | — | 41.8 |
| CaCO₃ | 53.8 | 53.8 | 53.8 | 53.8 | 53.8 | 53.8 | 53.8 |
| (Calofort SV) | | | | | | | |
| VTMO | 2.8 | 2.8 | 2.8 | 2.8 | 2.8 | 2.8 | 2.8 |
| GF9 | 1.4 | 1.4 | 1.4 | 1.4 | 1.4 | 1.4 | 1.4 |
| TIBKAT 223 | 0.2 | 0.2 | 0.2 | 0.2 | 0.2 | 0.2 | 0.2 |

The percentages are percentages by weight relative to the total weight of each sealant composition.

Measurement of the Tensile Strength by Tensile Testing:

The measurement of the tensile strength by tensile testing was performed according to the protocol described below.

The principle of the measurement consists in drawing, in a tensile testing device, the movable jaw of which is displaced at a constant rate equal to 100 mm/minute, a standard test specimen (H2) consisting of the crosslinked composition and in recording, at the moment when the test specimen breaks, the applied tensile stress (in MPa) and also the elongation of the test specimen (in %). The standard test specimen is dumbbell-shaped, as illustrated in the international standard ISO 37 of 2011. The narrow part of the dumbbell used has a length of 20 mm, a width of 4 mm and a thickness of 500 μm. The samples were stored under standard conditions (23° C.±1° C., 50%±5% RH) for 14 days. After 14 days, when the compositions have fully crosslinked, the tests were carried out on a ZWICK ROELL 2.5 KN tensile testing machine.

Measurement of the Skinning Time

The skinning time was measured in a controlled atmosphere at a temperature of 23° C. and a relative humidity of approximately 50%.

The composition was applied using a wooden spatula and in the form of a thin film on a slide on cardboard with a length of about 7 cm. Immediately after the application of said film, a stopwatch was started and it was examined every 15 minutes, using gentle pressure with an LDPE (low density polyethylene) pipette, if the film is dry or if a composition residue is transferred onto the pipette. The skinning time is the time at the end of which the composition film is dry and for which there is no longer any transfer of adhesive residue onto the pipette. The result is expressed in minutes.

The results are presented in the table below:

TABLE 3

| | Crosslinking | Tensile | Elongation |
|---|---|---|---|
| | time | strength | at break |
| Sealant | (min) | (in MPa) | (in %) |
| M1 (comparative) | 13 | 2.3 | 98 |
| M2 | 15 | 2.2 | 300 |
| M3 | 12 | 1.8 | 200 |
| M4 | 8 | 1.8 | 240 |
| M5 | 12 | 2.0 | 340 |
| M6 | 14 | 2.0 | 450 |
| M7 | 10 | 1.9 | 380 |

Thus, the sealants M2 to M7 according to the invention advantageously have a significantly higher elongation at break than for the comparative sealant M1. Moreover, it was observed that the sealants M3, M4 and M5 crosslink more rapidly than the comparative sealant M1.

1-17. (canceled)

18. A compound of formula (I) below: 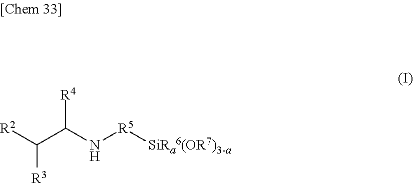
wherein:
R² is a radical selected from the group consisting of —C(O)OR¹, —C(O)NH₂, —CONHR¹, —C(O)N(R¹)₂, —CN, —NO₂, —PO(OR¹)₂, —SO₂R¹ and —SO₂OR¹;
R³ is a radical selected from the group consisting of a hydrogen atom, —CH₃, —R¹, —C(O)OR¹ and —CH₂C(O)OR¹;
R⁴ is a radical selected from the group consisting of a hydrogen atom, —R¹, —C(O)OR¹ and —CN;
R¹ represents an organic radical comprising from 1 to 20 carbon atoms, optionally comprising at least one heteroatom such as for example O;
R⁵ is a linear or branched divalent alkylene radical comprising from 1 to 12 carbon atoms;
R⁶ is a linear or branched alkyl group comprising from 1 to 8 carbon atoms, or an alkoxy group comprising from 1 to 8 carbon atoms;
R⁷ is a group —N═C(Rⁱ)R^{j} wherein:
Rⁱ is a radical selected from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a radical;
R^{j} is a radical selected from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
or Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom;
a is an integer equal to 0, 1 or 2.

19. The compound as claimed in claim 18, wherein R¹ represents a linear or branched alkyl group comprising from 1 to 20 carbon atoms.

20. The compound as claimed in claim 18, wherein:
R² is a radical —C(O)OR¹; and/or
R³ is a radical selected from the group consisting of a hydrogen atom, —C(O)OR¹ and —CH₂C(O)OR¹; and/or
R⁴ is a hydrogen atom or —C(O)OR¹; and
R¹ represents a linear or branched alkyl group comprising from 1 to 20 carbon atoms.

21. The compound as claimed in claim 18, wherein it has one of the following formulae (I-1), (I-2) or (I-3): 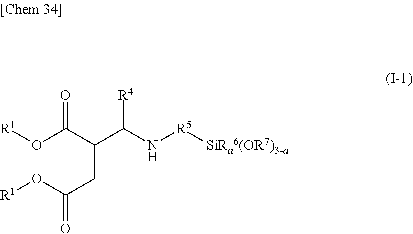
wherein a, R¹, R⁵, R⁶ and R⁷ are as defined in claim 18, and R⁴ represents H; 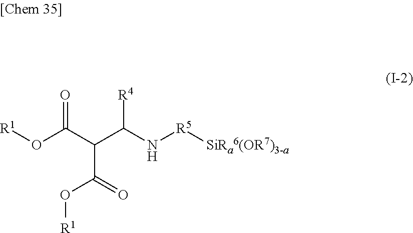
wherein a, R¹, R⁵, R⁶ and R⁷ are as defined in claim 18, and R⁴ represents H; 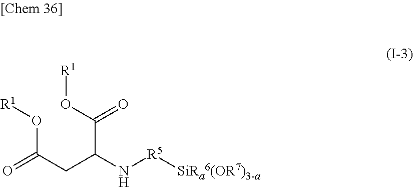
wherein a, R¹, R⁵, R⁶ and R⁷ are as defined in claim 18.

22. The compound as claimed in claim 18, wherein R⁷ is a group —N═C(Rⁱ)R^{j} wherein:
Rⁱ is a linear or branched alkyl radical comprising from 1 to 4 carbon atoms; and
R^{j} represents a linear or branched alkyl radical comprising from 1 to 8 carbon atoms.

23. The compound as claimed in claim 18, wherein it is selected from the following compounds:

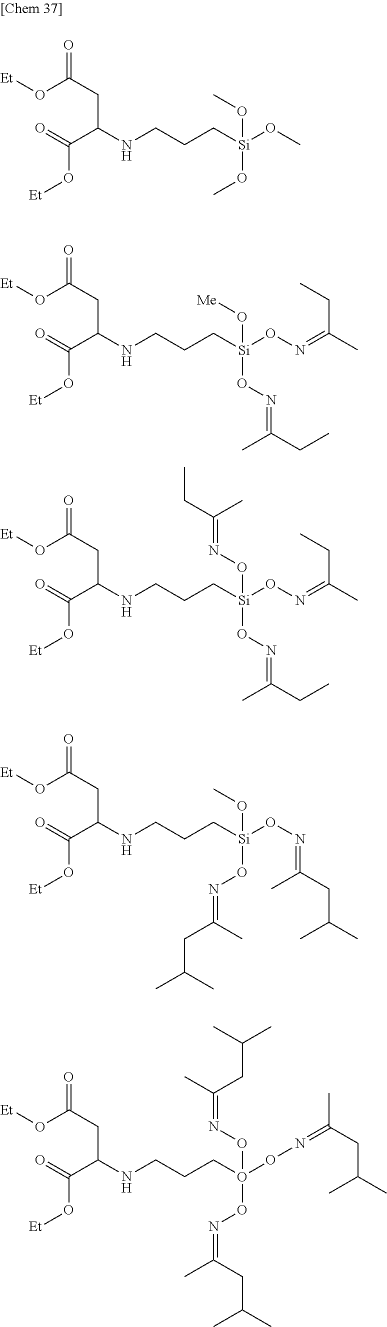

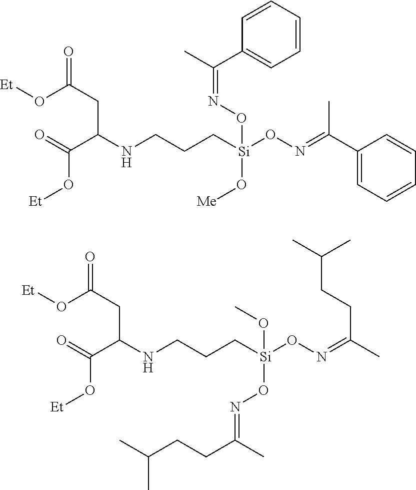 [SMILES: CCOC(=O)CC(NCCC[Si](OC)(O/N=C(/C)c1ccccc1)O/N=C(\C)c1ccccc1)C(=O)OCC ; CCOC(=O)CC(NCCC[Si](OC)(O/N=C(/C)CCC(C)C)O/N=C(\C)CCC(C)C)C(=O)OCC]

24. A process for preparing a compound of formula (I) as claimed in claim 18, comprising reacting a compound of formula (II) below: 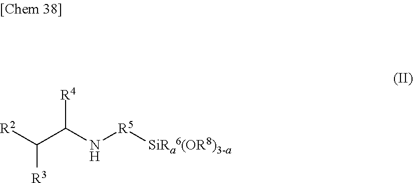
wherein:
R², R³, R⁴, R⁵, R⁶ and a are as defined in claim 18; and
R⁸ represents an alkyl radical or an acyl radical comprising from 1 to 8 carbon atoms;
with a compound of formula (III) below: 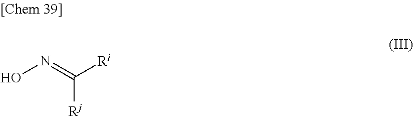
wherein Rⁱ and R^{j} are as defined in claim 18.

25. The process as claimed in claim 24, wherein the compounds of formula (II) are obtained by a process comprising reacting a compound of formula (IV) below: 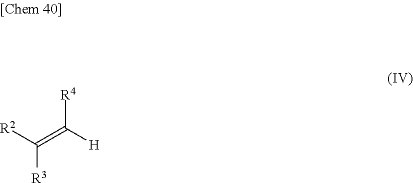
wherein R², R³ and R⁴ are as defined in claim 24;
with a compound of formula (V) below: 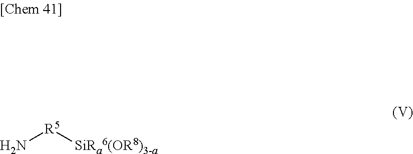
wherein a, R⁶, R⁵ and R⁸ and a are as defined in claim 24.

26. A silylated polyurethane P comprising at least one end function of formula (VI) below: 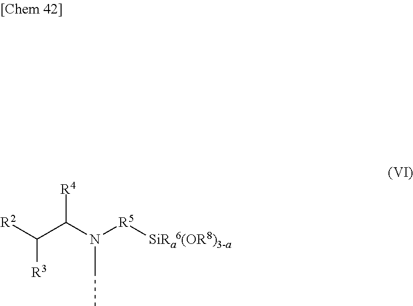
wherein:
R² is a radical selected from the group consisting of —C(O)OR¹, —C(O)NH₂, —CONHR¹, —C(O)N(R¹)₂, —CN, —NO₂, —PO(OR¹)₂, —SO₂R¹ and —SO₂OR¹;
R³ is a radical selected from the group consisting of a hydrogen atom, —CH₃, —R¹, —C(O)OR¹ and —CH₂C(O)OR¹;
R⁴ is a radical selected from the group consisting of a hydrogen atom, —R¹, —C(O)OR¹ and —CN;
R¹ represents an organic radical comprising from 1 to 20 carbon atoms, optionally comprising at least one heteroatom such as for example O;
R⁵ is a linear or branched divalent alkylene radical comprising from 1 to 12 carbon atoms;
R⁶ is a linear or branched alkyl group comprising from 1 to 8 carbon atoms, or an alkoxy group comprising from 1 to 8 carbon atoms;
R⁷ is a group —N═C(Rⁱ)R^{j} wherein:
Rⁱ is a radical selected from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms;
R^{j} is a radical selected from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
or Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom; and
a is an integer equal to 0, 1 or 2.

27. The silylated polyurethane P as claimed in claim 26, wherein:
R² is a radical —C(O)OR¹; and/or
R³ is a radical selected from the group consisting of a hydrogen atom, —C(O)OR¹ and —CH₂C(O)OR¹; and/or
R⁴ is a hydrogen atom or —C(O)OR¹; and
R¹ represents a linear or branched alkyl group comprising from 1 to 20 carbon atoms.

28. The silylated polyurethane P as claimed in claim 26, wherein it comprises at least one end function of formula (VI-1), (VI-2) or (VI-3) below: 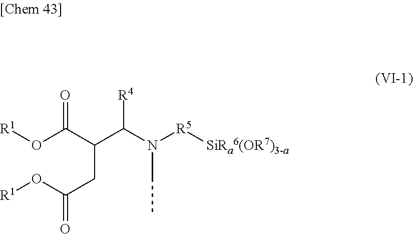
wherein a, R¹, R⁶, R⁷ and R⁵ are as defined in claim 26, and R⁴ represents H; 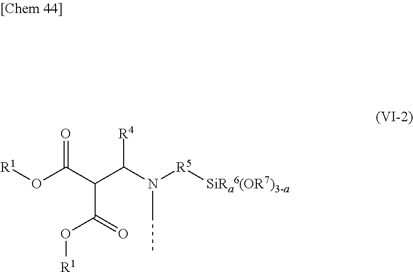
wherein a, R¹, R⁵, R⁶ and R⁷ are as defined in claim 26, and R⁴ represents H; 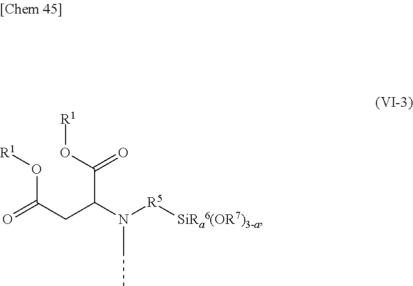
wherein a, R¹, R⁵, R⁶ and R⁷ are as defined in claim 26.

29. The silylated polyurethane P as claimed in claim 26, wherein:
each R¹, which may be identical or different, represents, independently of one another, a linear or branched alkyl group comprising from 1 to 12 carbon atoms; and
R⁴ represents a hydrogen atom; and
R⁵ represents a linear or branched divalent alkylene radical comprising from 1 to 6 carbon atoms.

30. The silylated polyurethane P as claimed in claim 26, wherein R⁷ is a group —N═C(Rⁱ)R^{j} wherein:
Rⁱ is a linear or branched alkyl radical comprising from 1 to 4 carbon atoms;
R^{j} represents a linear or branched alkyl radical comprising from 1 to 8 carbon atoms.

31. A silylated polyurethane P′ having the formula (VIII) below: 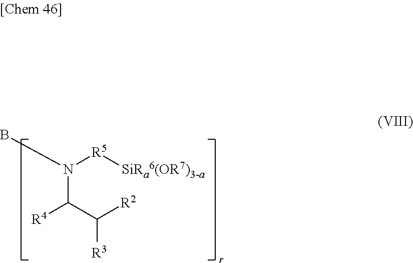
wherein:
B represents a multivalent organic radical;
r represents an integer or non-integer number ranging from 2 to 4;
R² is a radical selected from the group consisting of —C(O)OR¹, —C(O)NH₂, —CONHR¹, —C(O)N(R¹)₂, —CN, —NO₂, —PO(OR¹)₂, —SO₂R¹ and —SO₂OR¹;
R³ is a radical selected from the group consisting of a hydrogen atom, —CH₃, —R¹, —C(O)OR¹ and —CH₂C(O)OR¹;
R⁴ is a radical selected from the group consisting of a hydrogen atom, —R¹, —C(O)OR¹ and —CN;
R¹ represents an organic radical comprising from 1 to 20 carbon atoms, optionally comprising at least one heteroatom such as for example O;
R⁵ is a linear or branched divalent alkylene radical comprising from 1 to 12 carbon atoms;
R⁶ is a linear or branched alkyl group comprising from 1 to 8 carbon atoms, or an alkoxy group comprising from 1 to 8 carbon atoms;
R⁷ is a group —N═C(Rⁱ)R^{j} wherein:
Rⁱ is a radical selected from a hydrogen atom, a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a radical;
R^{j} is a radical selected from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical comprising from 6 to 12 carbon atoms, or a radical —CH₂—N(G¹G²) where G¹ and G² represent, independently of one another, a linear or branched alkyl radical comprising from 1 to 10 carbon atoms or a linear or branched alkenyl radical comprising from 2 to 10 carbon atoms or a benzyl radical;
or Rⁱ and R^{j} together form an aliphatic ring comprising from 3 to 14 carbon atoms, said aliphatic ring being optionally substituted with at least one alkyl group comprising from 1 to 4 carbon atoms, and said ring optionally comprising one or more heteroatoms selected from an oxygen atom, a sulfur atom or a nitrogen atom, said nitrogen atom then not being bonded to a hydrogen atom;
a is an integer equal to 0, 1 or 2.

32. The silylated polyurethane P′ as claimed in claim 31, wherein it has the formula (IX) below: 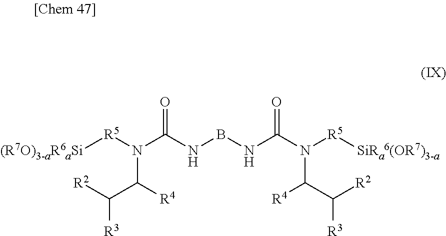
wherein:
B represents a multivalent organic radical; and
a, R², R³, R⁴, R⁵, R⁶ and R⁷ are as defined in claim 31.

33. The silylated polyurethane P′ as claimed in claim 31, wherein R⁷ is a group —N═C(Rⁱ)R^{j} wherein:
Rⁱ is a linear or branched alkyl radical comprising from 1 to 4 carbon atoms; and
R^{j} represents a linear or branched alkyl radical comprising from 1 to 8 carbon atoms.

34. A formulation comprising at least one polyurethane P as defined in claim 26 and at least one additive selected from the group consisting of catalysts, fillers, antioxidants, light stabilizers/UV absorbers, metal deactivators, antistatic agents, foaming agents, biocides, plasticizers, lubricants, emulsifiers, dyes, pigments, rheological agents, impact modifiers, adhesion promoters, optical brighteners, flame retardants, anti-sweating agents, nucleating agents, solvents, reactive diluents and mixtures thereof.
